(19) United States
(12) Patent Application Publication
(10) Pub. No.: US 2016/0208755 A1
(43) Pub. Date: Jul. 21, 2016

(54) FUEL INJECTION VALVE WITH CYLINDER INTERNAL PRESSURE SENSOR

(71) Applicant: KEIHIN CORPORATION, Tokyo (JP)

(72) Inventor: Gaku Sato, Utsunomiya-shi (JP)

(21) Appl. No.: 14/997,703

(22) Filed: Jan. 18, 2016

(30) Foreign Application Priority Data
Jan. 20, 2015 (JP) 2015-008441

(51) Int. Cl. F02M 57/00; G01M 15/08

(52) U.S. Cl. CPC F02M 57/005; G01M 15/08

(57) ABSTRACT

A signal transmitting unit that makes up a fuel injection valve includes a first signal transmitting member a distal end of which is connected to a sensor, and a second signal transmitting member a proximal end of which is connected to an amplifying member. A first connector of the first signal transmitting member is formed in a convex shape, and is inserted into a concave part of a second connector in the second signal transmitting member and connected by solder. At this time, a clearance in a radial direction is included between the first connector and the concave part. Further, a third connector is formed on a proximal end of the second signal transmitting member, and is inserted into a connecting hole of the amplifying member and connected by solder. Further, a clearance in a radial direction is included between the third connector and the connecting hole.

### CROSS-REFERENCE TO RELATED APPLICATION

This application is based upon and claims the benefit of priority from Japanese Patent Application No. 2015-008441 filed on Jan. 20, 2015, the contents of which are incorporated herein by reference.

### BACKGROUND OF THE INVENTION

1. Field of the Invention

The present invention relates to a fuel injection valve equipped with a cylinder internal pressure sensor, the sensor being capable of detecting a cylinder internal pressure in the interior of a combustion chamber, the fuel injection valve being used in a direct injection type internal combustion engine in which fuel is injected directly into the combustion chamber in the internal combustion engine.

2. Description of the Related Art

Heretofore, for example, as disclosed in Japanese Laid-Open Patent Publication No. 09-053483, with the aim of detecting a cylinder internal pressure of a combustion chamber in an internal combustion engine, it has been known to attach an internal pressure sensor to an end of a fuel injection valve. The internal pressure sensor is arranged between the end of the fuel injection valve and an attachment hole of a cylinder head that makes up the internal combustion engine. A lead line for transmitting to the exterior the detected cylinder internal pressure as a detection signal is connected to the internal pressure sensor. In addition, the lead line is connected, for example, to an electronic control unit, whereby a control or the like is performed based on the cylinder internal pressure by outputting the cylinder internal pressure as a detection signal to the electronic control unit.

### SUMMARY OF THE INVENTION

However, with the above-described internal pressure sensor that is mounted on the fuel injection valve, the lead line, which is connected to the internal pressure sensor and the electronic control unit, is exposed to the exterior of the fuel injection valve. Therefore, in an assembled condition, or when the internal pressure sensor is attached to the cylinder head together with the fuel injection valve, there is a concern that a disconnection may occur as a result of loads that are applied with respect to the lead line, and that detection of the cylinder internal pressure cannot be performed due to such a disconnection.

Further, with the aim of avoiding a risk of disconnection or the like as noted above, for example, although it may be considered to accommodate the lead line in the interior of the fuel injection valve, in the case that a single lead line is connected from the sensor to an output terminal, there is a concern that a disconnection may still occur due to a load (a tensile force or the like) applied at the time of assembly.

A general object of the present invention is to provide a fuel injection valve equipped with a cylinder internal pressure sensor, which makes it possible to prevent the occurrence of a disconnection or the like, by reducing loads applied to the signal transmitting unit during assembly thereof.

The present invention is characterized by a fuel injection valve equipped with a cylinder internal pressure sensor, the sensor being provided at an end of the fuel injection valve configured to directly inject fuel into a combustion chamber of an internal combustion engine, the sensor being configured to detect a cylinder internal pressure in an interior of the combustion chamber, the fuel injection valve including a signal transmitting member configured to transmit, as a detection signal, the cylinder internal pressure detected by the sensor. The signal transmitting member includes a first transmitting unit connected to the sensor, a second transmitting unit configured to externally output the detection signal, and a third transmitting unit configured to interconnect the first transmitting unit and the second transmitting unit. Clearances are provided, respectively, at a connection site between the first transmitting unit and the third transmitting unit, and at a connection site between the second transmitting unit and the third transmitting unit, and an intermediate portion of the third transmitting unit between both ends of the third transmitting unit is fixed with respect to a housing.

According to the present invention, in the fuel injection valve equipped with the cylinder internal pressure sensor that detects a cylinder internal pressure in the interior of a combustion chamber, the signal transmitting member is provided that transmits as a detection signal the cylinder internal pressure detected by the sensor. There are included the first transmitting unit connected to the sensor, and the second transmitting unit which externally outputs the detection signal. There is further included the third transmitting unit that interconnects the first transmitting unit and the second transmitting unit. An intermediate portion of the third transmitting unit is fixed to the housing, and clearances are provided, respectively, at a connection site between the first transmitting unit and the third transmitting unit, and at a connection site between the second transmitting unit and the third transmitting unit.

Consequently, when the first and second transmitting units are each assembled with respect to the third transmitting unit, an intermediate portion of which is fixed to the housing, since the first and second transmitting units are movable in radial directions over the clearances with respect to the third transmitting unit, for example, even in the case that manufacturing variances or variances in assembly of the first through third transmitting units occur, assembly thereof can be performed while such variances are suitably absorbed by the clearances.

As a result, even in the case that the signal transmitting member is constituted from the plurality of first through third transmitting units, load mutually applied with respect to the first through third transmitting units caused by manufacturing variances or the like can be suppressed, and the occurrence of a disconnection or the like in the signal transmitting member due to such load can reliably be prevented.

The above and other objects, features and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall front view, partially shown in cross section, of a fuel injection valve equipped with a cylinder internal pressure sensor according to an embodiment of the present invention;

FIG. 2 is an enlarged cross-sectional view showing the vicinity of a signal transmitting unit in the fuel injection valve equipped with the cylinder internal pressure sensor of FIG. 1;

FIG. 3A is an enlarged cross-sectional view showing the vicinity of a first connector in a second signal transmitting member of FIG. 2; and

FIG. 3B is an enlarged cross-sectional view showing the vicinity of a third connector in the second signal transmitting member of FIG. 2.

### DESCRIPTION OF THE PREFERRED EMBODIMENTS

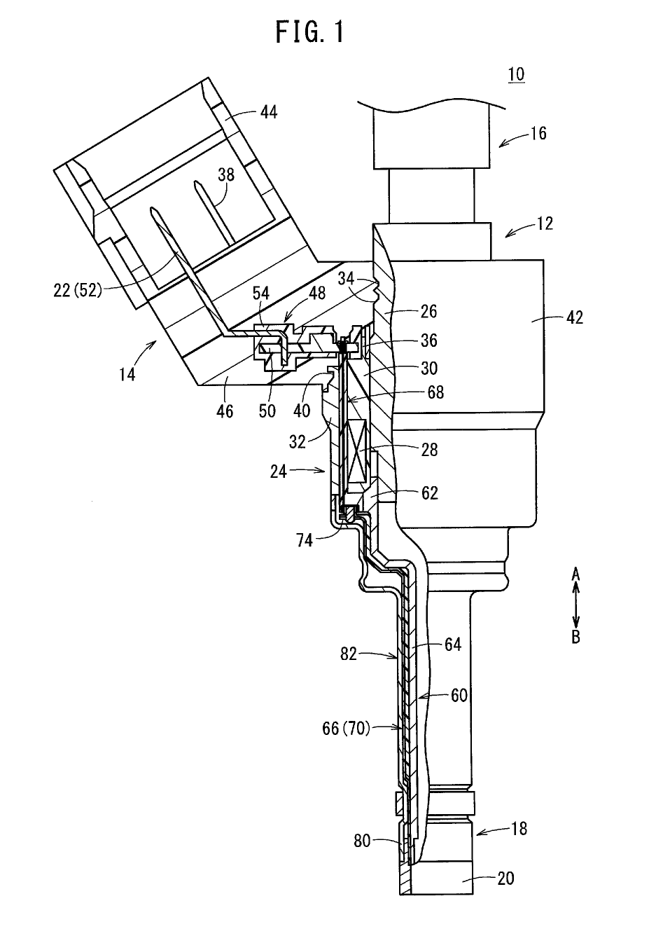

As shown in FIG. 1, a fuel injection valve 10 equipped with a cylinder internal pressure sensor (hereinafter referred to simply as a fuel injection valve 10) includes a housing 12, a resin mold portion 14 connected to an outer circumferential side of the housing 12, a fuel supply unit 16 disposed on a proximal end of the housing 12 and to which fuel is supplied, a fuel injector 18 disposed on a distal end of the housing 12, a sensor 20 mounted on a distal end of the fuel injector 18, and a signal transmitting unit (signal transmitting member) 24 that electrically interconnects the sensor 20 and a signal terminal (second transmitting unit) 22 connected to a non-illustrated electronic control unit (ECU) and thereby transmits output signals therebetween.

Below, the side of the fuel supply unit 16 in the fuel injection valve 10 will be referred to as a proximal end side (in the direction of the arrow A), and the side of the fuel injector 18 will be referred to as a distal end side (in the direction of the arrow B).

The housing 12, for example, is constituted as a solenoid unit that drives the fuel injection valve 10. The housing 12 includes a fixed core 26 that is disposed in the center thereof, a bobbin 30 that is provided on an outer circumferential side of the fixed core 26 and retains a coil 28, a cylindrical holder 32 disposed further on a distal end outer circumferential side of the bobbin 30, and a movable core (not shown) that is displaced under a magnetically excited action of the coil 28.

The fixed core 26 extends further to the proximal end side (in the direction of the arrow A) of the housing 12 with respect to the proximal end of the holder 32, and is arranged in the center of the later-described resin mold portion 14. Annular first grooves 34, which are engaged with the later-described resin mold portion 14, are formed on the outer circumferential surface of the fixed core 26. Further, the fuel supply unit 16 is disposed on the proximal end side of the fixed core 26.

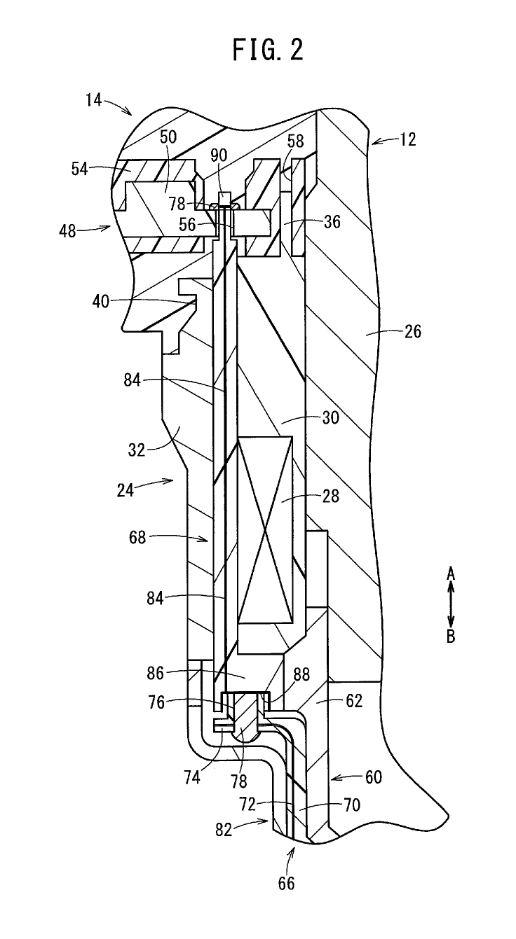

The bobbin 30, for example, is formed in a cylindrical shape, and is disposed between the fixed core 26 and the holder 32. An engagement pin 36 (see FIG. 2), which is engaged with an amplifying member (second transmitting unit) 48, is formed on the proximal end side (in the direction of the arrow A) of the bobbin 30. Further, on an outer circumferential side of the bobbin 30, the coil 28 is wound in a radially inward recessed location, and a second signal transmitting member (third transmitting unit) 68 that makes up the later-described signal transmitting unit 24 is retained on the outer circumferential side of the coil 28. The engagement pin 36 is disposed at a position on the side of a coupler 44 of the later-described resin mold portion 14, in a circumferential direction of the cylindrical bobbin 30.

Ends of the coil 28 extend to the proximal end side (in the direction of the arrow A) of the bobbin 30, and are connected respectively to ends of a pair of drive terminals 38 that are incorporated in the later-described resin mold portion 14. In addition, by the coil 28 being supplied with electric current from non-illustrated connectors through the drive terminals 38, the coil 28 is excited and a magnetic force is generated. Owing to this feature, under a magnetic excitation action of the coil 28 in the housing 12, the non-illustrated movable core is displaced inside the bobbin 30, and the valve element (not shown) disposed in the fuel injector 18 is attracted, and a valve open condition is brought about.

Further, on a proximal end outer circumferential surface of the holder 32, a radially inward recessed annular second groove 40 is formed, and the later-described resin mold portion 14 is engaged therein.

The resin mold portion 14, for example, is formed on the outer circumferential side of the housing 12 by being molded from a resin material. The resin mold portion 14 includes a main body section 42, which is formed in a cylindrical shape, the coupler 44 that projects out sideways from the proximal end of the main body section 42, and a connector 46 that interconnects the main body section 42 and the coupler 44.

In addition, by the resin mold portion 14 being molded from the resin material, the molten resin material enters respectively into the first grooves 34 of the fixed core 26 disposed in the center of the main body section 42, and the second groove 40 of the holder 32 disposed on the distal end side of the main body section 42, whereupon the housing 12 becomes fixed with respect to the center and the distal end of the resin mold portion 14.

The coupler 44 is formed, for example, with a rectangular shape in cross section, and projects in an obliquely upward direction, so as to be inclined at a predetermined angle with respect to the axial direction (the direction of arrows A and B) of the main body section 42. Further, an end of the coupler 44 is opened and includes a space in the interior thereof, with power source terminals 52 and the signal terminal 22 of the later-described amplifying member 48, and the pair of drive terminals 38 for energizing the coil 28 being provided in an outwardly exposed manner therein, respectively.

The amplifying member 48, for example, is disposed in the interior of the resin mold portion 14. The amplifying member 48 includes a substrate 50 with a rectangular cross section, the power source terminals 52 and the signal terminal 22 that are connected electrically to the substrate 50, and a sealing member 54, which is formed so as to cover the entirety of the substrate 50. The amplifying member 48 is provided with the aim of amplifying a detection value detected by the sensor 20, and outputting the amplified detection value to the exterior from the signal terminal 22.

On one end of the substrate 50, the signal terminal 22 and the power source terminals 52 are connected electrically by solder or the like, whereas on the other end side of the substrate 50, a connecting hole 56 (see FIG. 2) is formed, which is connected with the second signal transmitting member 68 of the later-described signal transmitting unit 24.

The sealing member 54 is formed, for example, from a resin material. In a state in which the ends of the power source terminals 52 and the signal terminal 22 are connected with respect to the substrate 50, the sealing member 54 is formed so as to cover at a predetermined thickness the entirety of the substrate 50, and to cover the ends of the power source terminals 52 and the signal terminal 22 that are connected to the substrate 50.

Further, in the sealing member 54, as shown in FIG. 2, an engagement hole 58, which penetrates through the sealing member 54 in a thickness direction, is formed on an end thereof on an opposite side from the end on the side of the power source terminals 52. The engagement pin 36 of the bobbin 30 that constitutes the housing 12 is capable of being inserted in the engagement hole 58.

In addition, when the resin mold portion 14 is molded, the amplifying member 48 is integrally molded therein in a state that the engagement pin 36 of the bobbin 30 is inserted in the engagement hole 58 of the sealing member 54 and the amplifying member 48 is thus positioned. Further, at the same time, an end of the amplifying member 48, which resides on an opposite side from the end where the power source terminals 52 are connected, is connected to the signal transmitting unit 24.

By connecting a non-illustrated connector to the coupler 44, electrical power is supplied to the amplifying member 48 and the sensor 20 through the power source terminals 52, a detection value which is detected by the sensor 20 is output externally as an electrical signal through the signal terminal 22, and electric current to energize the coil 28 of the housing 12 is supplied from the drive terminals 38.

As shown in FIG. 1, the fuel supply unit 16, for example, includes a supply passage (not shown) through which fuel is supplied, in the interior of the fixed core 26, and a non-illustrated fuel pipe is connected to an end of the supply passage that opens on the proximal end side (in the direction of the arrow A) of the fuel injection valve 10. In addition, the fuel supplied through the fuel pipe passes through the supply passage, and is supplied to the side of the fuel injector 18 (in the direction of the arrow B) disposed on the distal end side.

The fuel injector 18 comprises a valve housing 60 that is connected to a distal end of the housing 12, and a valve element (not shown) that is incorporated in the distal end of the valve housing 60. In addition, fuel is supplied from the fuel supply unit 16 into the interior of the valve housing 60, and by the valve element being moved toward the proximal end side (in the direction of the arrow A) upon excitation of the coil 28, fuel is injected from the distal end into the combustion chamber at a predetermined pressure.

The valve housing 60, for example, is formed from a metallic material. The valve housing 60 includes a first flange 62 that closes the distal end of the housing 12, and a tubular portion 64 that extends along a straight line to the distal end side (in the direction of the arrow B) from the first flange 62. The cylindrical sensor 20 is press-inserted and fitted on an outer circumferential side on the distal end of the tubular portion 64.

The sensor 20, for example, is equipped with a piezoelectric element (not shown) in the interior thereof, and connection terminals, which are connected to the piezoelectric element, are exposed on the proximal end side (in the direction of the arrow A). Further, a retaining portion 80 of a later-described cover member 82 abuts on the outer circumferential surface of the sensor 20. In addition, a distal end inner circumferential side of the sensor 20, for example, is coupled by being welded around the entire circumference with respect to the valve housing 60.

As shown in FIGS. 1 through 3B, the signal transmitting unit 24 includes a first signal transmitting member (first transmitting unit) 66 disposed on the outer circumferential side of the valve housing 60 and connected to the sensor 20, and a second signal transmitting member 68 accommodated in the holder 32 of the housing 12, and which connects the first signal transmitting member 66 and the signal terminal 22.

The first signal transmitting member 66, for example, includes an insulating body 70 formed in a cylindrical shape from a resin material, and which is disposed on the outer circumferential side of the tubular portion 64 in the valve housing 60, and a first conductive layer 72 disposed in the interior of the insulating body 70. In addition, the first conductive layer 72 is electrically connected, for example by solder or the like, to a connection terminal of the sensor 20.

The insulating body 70, for example, is formed from a resin material such as a heat resistant resin or the like, and on the proximal end side thereof, a second flange 74 is formed, which is expanded in diameter correspondingly to the shape of the valve housing 60 so as to cover the first flange 62.

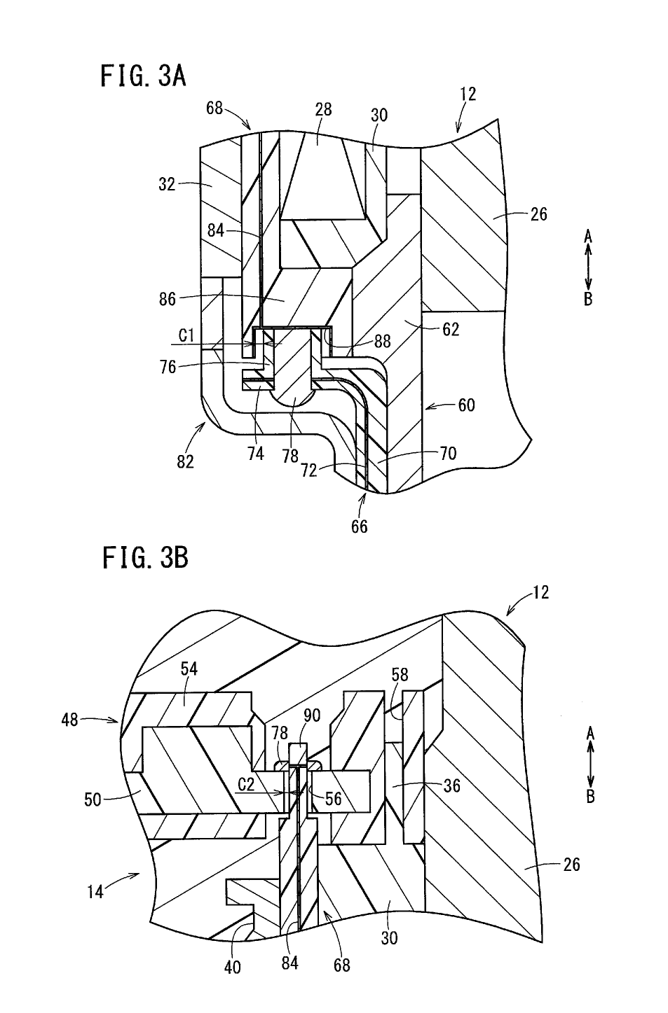

As shown in FIGS. 2 and 3A, the second flange 74 is arranged below the first flange 62, and includes a first connector 76 that is formed in a convex shape toward the second signal transmitting member 68 (in the direction of the arrow A). The first connector 76 is formed in a cylindrical shape projecting out at a predetermined height substantially perpendicularly with respect to the second flange 74, and is capable of being filled with solder 78 or the like in the interior thereof.

Further, the first conductive layer 72, which is made up from a plating layer, for example, is formed in the center in the thickness along a diametrical direction of the insulating body 70, and the first conductive layer 72 is formed in a cylindrical shape along the insulating body 70 at a substantially constant thickness. A distal end of the insulating body 70 is press-inserted and fitted into the interior of the sensor 20 and around the tubular portion 64 of the valve housing 60, and the proximal end thereof is exposed on an inner circumferential surface of the first connector 76.

On the other hand, as shown in FIG. 1, on an outer circumferential side of the insulating body 70, the cover member 82, which is formed, for example, in a cylindrical shape from a metallic material, is mounted so as to cover the insulating body 70. The cover member 82 is formed such that the proximal end side thereof (in the direction of the arrow A) is expanded in diameter correspondingly to the shape of the valve housing 60 so as to cover the tubular portion 64 and the first flange 62. The retaining portion 80 that retains the outer circumferential surface of the proximal end side of the sensor 20 is formed on the distal end of the cover member 82.

As shown in FIG. 2, the second signal transmitting member 68 is formed, for example, from a resin material, and is constituted in a plate shape having a predetermined length along the axial direction (the direction of arrows A and B), and a substantially central vicinity thereof along the axial direction is fixed with respect to the bobbin 30.

Further, a second conductive layer 84, which is formed from an electrically conductive material, is formed in the interior of the second signal transmitting member 68. The second conductive layer 84 is formed, for example, from a plating layer, which extends at a substantially constant thickness from the distal end to the proximal end along the axial direction (the direction of arrows A and B) of the second signal transmitting member 68.

As shown in FIGS. 2 and 3A, on the distal end of the second signal transmitting member 68, a second connector 86 is formed, which projects in a radially inward direction perpendicularly to the axis. The second connector 86 is formed so as to face toward the proximal end of the first signal transmitting member 66, and includes a concave part 88 in which the first connector 76 of the first signal transmitting member 66 can be inserted. The concave part 88 opens toward the first signal transmitting member 66 (in the direction of the arrow B), with an end of the second conductive layer 84 being exposed on an inner circumferential surface thereof, and when the first connector 76 is inserted into the interior thereof, a clearance C1 (see FIG. 3A) of a predetermined interval is included along the diametrical direction.

In addition, the first connector 76 of the first signal transmitting member 66 is inserted into the second connector 86, and then the second conductive layer 84, which is exposed in the concave part 88, and the first conductive layer 72 of the first signal transmitting member 66 are connected electrically by solder 78 or the like.

On the other hand, as shown in FIGS. 2 and 3B, a small diameter third connector 90, which is reduced in diameter with respect to the distal end side, is included on the proximal end of the second signal transmitting member 68. A portion of the second conductive layer 84 is exposed in an annular shape on the third connector 90 along the outer circumferential surface thereof.

In addition, by the third connector 90 being inserted into the connecting hole 56 formed of the substrate 50 in the amplifying member 48 and electrically connected by solder 78 or the like, the second signal transmitting member 68 is connected electrically with the amplifying member 48. At this time, a clearance C2 (see FIG. 3B) of a predetermined interval along the diametrical direction of the third connector 90 is provided between the third connector 90 and the connecting hole 56.

Consequently, a condition is brought about in which the signal terminal 22 and the power source terminals 52 are connected electrically and mutually with the sensor 20 through the first and second signal transmitting members 66, 68.

The fuel injection valve 10 equipped with a cylinder internal pressure sensor according to the embodiment of the present invention is constructed basically as described above. Next, a description will be given concerning assembly of the signal transmitting unit 24.

At first, the first connector 76 of the first signal transmitting member 66 is inserted into the second connector 86 of the second signal transmitting member 68 that is mounted and retained in the bobbin 30 that makes up the housing 12, together with the third connector 90 of the second signal transmitting member 68 being inserted into the connecting hole 56 of the amplifying member 48. At this time, the interior of the first connector 76 is filled beforehand with the solder 78.

Further, since the first connector 76 is formed to be slightly smaller in the radial direction than the concave part 88 of the second connector 86, and the clearance C1 exists in the radial direction between both of the connectors, even in the case that manufacturing variances or variances in assembly occur in the first signal transmitting member 66 and the second signal transmitting member 68, such variances are suitably absorbed by the clearance C1. Furthermore, when the third connector 90 is inserted into the connecting hole 56 of the amplifying member 48, since the clearance C2 exists in the radial direction between the connecting hole 56 and the third connector 90, even in the case that manufacturing variances or variances in assembly occur in the second signal transmitting member 68 and the amplifying member 48, such variances are suitably absorbed by the clearance C2.

Next, in a state in which the first signal transmitting member 66, the second signal transmitting member 68, and the amplifying member 48 are connected, by applying heat from the outer side of the signal transmitting unit 24 using a heating device, for example, the solder 78 is melted, whereupon the first conductive layer 72 of the first connector 76 and the second conductive layer 84 of the second connector 86 are connected electrically, and the second conductive layer 84 of the third connector 90 and the substrate 50 of the amplifying member 48 are connected electrically.

Next, operations of the fuel injection valve 10, in which the signal transmitting unit 24 has been assembled in the foregoing manner, will be described.

In a non-illustrated internal combustion engine during driving, by a control signal from the electronic control unit, the coil 28 is energized from the drive terminals 38 of the fuel injection valve 10, so that the coil 28 is excited. Then, the valve element of the fuel injector 18 is placed in a valve open state, and high pressure fuel, which is supplied to the supply passage of the fuel supply unit 16, is injected directly into the combustion chamber of the internal combustion engine through the fuel injector 18. At this time, by a pressure (cylinder internal pressure) in the combustion chamber being applied, the piezoelectric element of the sensor 20 generates a voltage corresponding to the pressure, which is output as an output signal.

The detection signal is output to the amplifying member 48 via the sensor 20, the first signal transmitting member 66, and the second signal transmitting member 68, and after the detection signal has been amplified in the amplifying member 48, the detection signal is output to the electronic control unit through the signal terminal 22.

In addition, for example, in the electronic control unit, the pressure of the combustion chamber is calculated from the amplified output signal, and based on the calculated pressure, a combustion control or the like can be performed.

As has been described above, according to the present embodiment, in the signal transmitting unit 24 of the fuel injection valve 10, there are included the first signal transmitting member 66, which is connected to the sensor 20, the second signal transmitting member 68, which is connected to the amplifying member 48, and the amplifying member 48 in which the signal terminal 22 is included. In addition, the first connector 76, which is disposed on the proximal end of the first signal transmitting member 66, is inserted into the concave part 88 of the second connector 86 provided on the distal end of the second signal transmitting member 68, and the third connector 90 of the second signal transmitting member 68 is inserted into the connecting hole 56 of the amplifying member 48. At this time, the clearances C1, C2 of predetermined intervals in the radial direction are provided, respectively, between the first connector 76 and the second connector 86, and between the third connector 90 and the connecting hole 56.

Consequently, when the first signal transmitting member 66, the second signal transmitting member 68, and the amplifying member 48 are assembled together mutually, since the members can be moved relatively in radial directions over the clearances C1, C2, even in the case that manufacturing variances or variances in assembly occur in the first signal transmitting member 66, the second signal transmitting member 68, and the amplifying member 48, such variances can suitably be absorbed by allowing movement within the clearances C1, C2. Therefore, the occurrence of loads caused by manufacturing variances or the like can be suppressed, and the occurrence of a disconnection or the like in the signal transmitting unit 24 due to such loads can reliably be prevented.

Further, the second signal transmitting member 68 is positioned by a substantially central portion thereof along the axial direction being retained with respect to the bobbin 30. Thus, while the first signal transmitting member 66 and the amplifying member 48 undergo movement to predetermined positions through the clearances C1, C2 with respect to the positioned second signal transmitting member 68, assembly thereof can be performed.

The fuel injection valve equipped with a cylinder internal pressure sensor according to the present invention is not limited to the embodiment described above, and various additional or modified configurations may be adopted therein without departing from the scope of the present invention as set forth in the appended claims.

What is claimed is:

1. A fuel injection valve equipped with a cylinder internal pressure sensor, the sensor being provided at an end of the fuel injection valve configured to directly inject fuel into a combustion chamber of an internal combustion engine, the sensor being configured to detect a cylinder internal pressure in an interior of the combustion chamber, the fuel injection valve comprising:
a signal transmitting member configured to transmit, as a detection signal, the cylinder internal pressure detected by the sensor;
wherein the signal transmitting member comprises:
a first transmitting unit connected to the sensor;
a second transmitting unit configured to externally output the detection signal; and
a third transmitting unit configured to interconnect the first transmitting unit and the second transmitting unit;
wherein clearances are provided, respectively, at a connection site between the first transmitting unit and the third transmitting unit, and at a connection site between the second transmitting unit and the third transmitting unit, and an intermediate portion of the third transmitting unit between both ends of the third transmitting unit is fixed with respect to a housing.

2. The fuel injection valve equipped with the cylinder internal pressure sensor according to claim 1, wherein the clearances are disposed in a direction perpendicular to a direction of extension of the third transmitting unit.
